(19) United States
(12) Patent Application Publication
(10) Pub. No.: US 2026/0211800 A1
(43) Pub. Date: Jul. 23, 2026

(54) NON-UI TEST AUTOMATION FOR WEB APPLICATIONS

(71) Applicant: SAP SE, Walldorf (DE)

(72) Inventors: Shanavas Madeen S, Krishnagiri (IN); Naveen V, Hariharapura (IN)

(73) Assignee: SAP SE, Walldorf (DE)

(21) Appl. No.: 19/035,699

(22) Filed: Jan. 23, 2025

(51) Int. Cl. G06F 11/3668

(52) U.S. Cl. CPC G06F 11/3688; G06F 11/3696

(57) ABSTRACT

A non-user-interface (non-UI) test automate associated with a web application test case includes a sequence of state-change requests. The state-change requests and responses thereto are captured during recording of a UI test automate for the test case or adapted from an existing UI test automate for the test case, whereas non-state-change requests of the corresponding UI test automate are excluded from the non-UI test automate. Responsive to a prompt to perform a non-UI automated test for the test case, mappings between properties of the state-change requests, responses, and test data are determined. At runtime of the non-UI test automate, the mappings are referenced to preserve sequence and data dependencies among the state-change requests. Pop-up window content received in network responses during execution of the non-UI test automate is classified by type using a classification machine learning model and handled based on the determined type.

### FIELD

The field generally relates to test automation for web applications.

### BACKGROUND

With the fast-paced development and delivery of innovations, software vendors and consumers rely heavily on automated testing. For web applications, two common types of automated testing include user interface (UI) test automation and Application Programming Interface (API) test automation. In UI test automation, automated tests (also referred to as test automates) interact with a web application as an end user would. In API test automation, automated tests interact directly with the backend of a web application, bypassing the UI layer.

UI test automation and API test automation have different strengths and weaknesses. For example, as UI test automation links frontend processes with backend processes, it can be time-consuming and resource-intensive. Further, UI test automation may fail due to UI dependencies and often lacks detailed insights into underlying issues. Conversely, API test automation focuses solely on backend processes, making it quicker and less resource-intensive. API test automation can succeed where UI test automation fails and provides clear fault analysis related to backend processes. However, API test automation does not test frontend processes and cannot perform data-integrated checks. Therefore, despite the speed and efficiency of API test automation, it cannot entirely replace UI test automation.

### BRIEF DESCRIPTION OF THE DRAWINGS

FIG. is a block diagram of an example system implementing non-UI test automation for web applications.

FIG. is a flowchart of an example method of capturing user interactions with a web application.

FIG. depicts example code for monitoring network requests to identify state-change requests and example code for a state change handler function.

FIG. is a block diagram of an example UI for creation of a sales document.

FIG. 5 is a block diagram of an example UI displaying a sequence of recorded user interactions.

FIG. depicts example code for a state-change request.

FIG. is a flowchart of an example method of performing an automated test for a web application.

FIG. 8 is a flowchart of an example method of responding to a prompt to perform a non-UI automated test.

FIG. 9 is a block diagram of an example system implementing machine learning for classification of pop-up window content.

FIG. depicts an example pop-up window and an example response comprising pop-up-window content.

FIG. is a flowchart of an example method of classifying pop-up window content.

FIG. 12 is a graph showing execution times of UI automated tests and non-UI automated tests.

FIG. 13 is a block diagram of an example computing system in which described embodiments can be implemented.

FIG. 14 is a block diagram of an example cloud computing environment that can be used in conjunction with the technologies described herein.

### DETAILED DESCRIPTION

### Example—Overview

Non-UI test automation for web applications can be implemented to achieve performance similar to that of UI test automation in a quick and user-friendly manner. Towards this end, non-UI test automates can be generated and stored for later use. Generation of a given non-UI test automate can include capturing a sequence of request-response pairs using a test automation tool (e.g., a low-code or no-code test automation tool); alternatively, an existing UI test automate for a test case can be adapted to generate a corresponding non-UI test automate for the test case.

During creation of a UI test automate for a web application test case using a test automation tool, an end user performs a series of interactions with a UI of the web application (e.g., a UI displayed in a web browser). The test automation tool records the user interactions in sequence for later playback during execution of the resulting UI test automate. A corresponding non-UI test automate for the test case can be created either during the recording of the user interactions or during subsequent playback of the recorded user interactions. In either case, during creation of the non-UI test automate for the test case, the test automation tool captures certain network requests triggered by the user interactions and responses thereto (referred to herein as request-response pairs), in sequence. Network requests, which can alternatively be referred to as network calls or service calls, refer to communications from the web application frontend (e.g., a browser) to the web application backend (e.g., a server).

Notably, during creation of the non-UI test automate, request-response pairs are not captured for all network requests triggered by the user interactions of the corresponding UI test automate; instead, only state-change requests and responses thereto are captured. As used herein, a state-change request is a network request that triggers a change in the state of the web application. In the context of stateful web applications, not every user interaction will trigger a change in the state of the web application, which is maintained at the web application backend. Network requests that, when executed, trigger a change in the state of the web application at the backend are referred to herein as state-change requests. For ease of explanation, operations performed at the web application backend during execution of state-change requests (i.e., operations which bring about changes in the state of the web application at the web application backend) are referred to herein as state-change operations.

In contrast, any non-state-change requests triggered by the user interactions of the corresponding UI test automate are not captured and thus not included in the non-UI test automate. As used herein, a non-state-change request is a network request that does not trigger any changes in the state of the web application (e.g., a network request that triggers changes at the web application frontend, but does not change the stored state of the web application stored at the web application backend). Accordingly, the capturing of the pairs of state-change requests and responses thereto is an automated process which serves to filter relevant non-state-change requests from the exhaustive list of network requests triggered during recording of a test case, which includes non-state-change requests to load the UI and various resources in addition to state-change requests.

During adaption of an existing UI test automate for a test case to generate a corresponding non-UI test automate for the test case, the test automation tool can execute the existing UI test automate and capture the sequence of request-response pairs during the execution. For example, a sequence of request-response pairs can be adapted from a pre-existing UI test automate by executing the pre-existing UI test automate and capturing the state-change requests and responses to the state-change requests during the execution of the pre-existing UI test automate.

In either case, the sequence of request-response pairs can be stored and subsequently fetched in response to a prompt to perform a non-UI automated test for the test case. The prompt can include data for the test (e.g., data input by the user who initiated the test, to be used in place of the test data that was used when the sequence was captured). The new test data included in the prompt, also referred to herein as runtime data, can include key-value pairs.

After the stored sequence of request-response pairs is fetched in response to the prompt, mapping logic is applied to ensure that appropriate sequence and data dependencies are maintained at runtime. Towards this end, the mapping logic loops through the state-change requests and establishes mappings between properties of earlier responses and properties of upcoming state-change requests in the sequence, as well as between properties of the runtime data for the test execution and properties of the state-change requests.

After the mapping process, the non-UI automated test is run by executing the state change requests in sequence; in this context, executing a sequence of state-change requests can alternatively be referred to as executing a non-UI test automate for the test case. During execution of a given non-UI test automate, the state-change requests are modified based on the mappings and played back in sequence with the runtime data. Notably, unlike execution of UI test automates, execution of the non-UI test automates described herein does not require launching a web application UI (e.g., in a browser), hence the term “non-UI.”

During execution of the test, values which convey correctness of the executions can optionally be exported to measure success (e.g., a generated sales order number). Additionally, if there are any issues during execution of the state-change requests, error responses are logged and output. For example, the error responses can be displayed to the end user with user-friendly error messages abstracted from the corresponding responses.

In some examples, during execution of a non-UI test automate, a state-change request receives a response which would trigger the launch of a pop-up window if received in the context of UI test automation (e.g., a pop-up window containing a message with a text notification for the user). Because the non-UI test automate execution does not take place in a browser, a pop-up window is not launched, and thus the user executing the test is unable to manually close the pop-up window to dismiss the notification such that the test can proceed (or terminate, if there is an error that prevents further execution). In accordance with disclosed techniques, an intelligent classification model is applied to the content of such a response to determine a type of the associated pop-up window content and handle the response accordingly (e.g., by executing one or more additional network requests selected based on the type). Accordingly, the execution of the non-UI test automate can either proceed (e.g., if the pop-up window content pertains to an information or warning type of pop-up window) or be terminated (e.g., if the pop-up window content pertains to an error type of pop-up window), without user intervention.

The techniques for non-UI test automation described herein advantageously achieve similar results as UI test automation without requiring launching of a dedicated browser for test execution. Accordingly, because the UI layer is not involved, execution of a given non-UI test automate can be completed in a significantly shorter time as compared to execution of a UI test automate for the same test case. Furthermore, the disclosed techniques can be implemented by end users who lack technical skills such as understanding of network request structure, request dependencies (e.g., sequence and data dependencies), and data mapping.

### Example—Example Test Automate

Test automates are employed at design-time during different stages of software development, as well as run-time in a production environment. For example, during development, test automates may be executed for code changes released as part of a code pipeline. As another example, test automates may be executed at regular intervals to ensure functionality of a given software product is regression-free and that integrating functions works in unison. Such tests include, for example, daily tests, process tests, qualification tests, customer testing for their specific implementations and configuration, content tests, and end-to-end integration tests.

A test automate can be implemented as a software object that includes an automation script. The automation script may be written in a programming language such as Selenium, Tricentis Tosca™, Katalon™, Cypress, or the like. Accordingly, a software object referred to as a test automate can contain computer-readable instructions which, when executed, perform an automated test (e.g., a test which does not require or involve any user interaction). The software object can be an Extensible Markup Language (XML) object, a JavaScript Object Notation (JSON) object, a .Java file, or another type of software object.

As another example, a test automate can be implemented as an object within a framework that supports a keyword-driven approach. In such frameworks, keywords are used to dictate the actions of the test automate, thereby simplifying the process of scripting tests. In either case, a test automate refers to a software object which can be executed on demand in an automated manner, without requiring any user interaction for its functionality.

In some examples, in addition to test automates provided by a software platform, a customer of the software platform may have the capability to use their own automation tools to generate their own test automates. For example, the customer may use automation tools to generate customer-supplied test automates. The technologies described herein can also be applied to such customer-supplied test automates.

Herein, non-UI test automates and UI test automates are described. Execution of the non-UI test automates, which can alternatively be referred to as UI-less test automates, processing layer test automates, or business layer test automates, does not involve any processing by the UI of the web application and thus does not require launching of the UI. Instead, the test script of a given non-UI test automate can include a sequence of captured state-change requests (e.g., network requests that trigger backend operations) which undergoes refinement via mapping logic during execution.

In contrast, execution of the UI test automates, which can alternatively be referred to as UI mode test automates or presentation layer test automates, does involve processing by the UI of the web application (i.e., processing by the presentation layer) and thus does require launching of the UI.

### Example—Example Test Case

A given test automate can execute one or more corresponding test cases. A test case refers to a specific scenario composed of a sequence of steps, conditions, and inputs that validate a particular behavior of a software application. Towards this end, a test case may include a test case identifier, a description which explains what the test case will validate, one or more preconditions, one or more test steps (e.g., actions to be performed in the test), and expected results. After execution of a test case, the test case may also include actual results documenting the results of execution of the test case, and status (e.g., pass or fail depending on whether the actual results match the expected results).

One example type of test case that may be executed by the test automates described herein is a test case for UI test automation. A test case for UI test automation can include a set of steps and assertions that validate the behavior and functionality of a UI element or a series of UI interactions. Test cases for UI test automation typically involve simulating user actions such as clicking buttons, entering text into input fields, and verifying that the expected outcomes occur. As described herein, when a UI test automate for test case for a UI test automation is executed, the UI interactions are simulated; in contrast, when corresponding non-UI test automate for the test case is executed, certain network requests triggered by the UI interactions are simulated rather than the UI interactions themselves.

### Example—Example System Implementing Non-UI Test Automation for Web Applications

FIG. 1 is a block diagram of an example system 100 implementing non-UI test automation for web applications. In the example, the system 100 includes a server computing system 102, a client computing system 104, a database management system 106 including a database 107, and a test automation database 116. While a single instance of each system is depicted for ease of explanation, system 100 may include multiple server computing systems, client computing systems, and/or database management systems in practice.

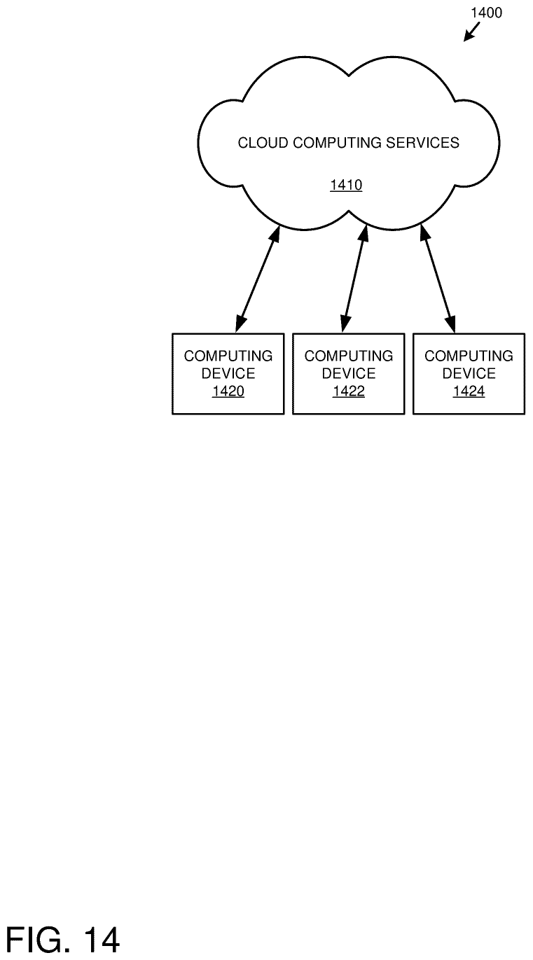

Any of the systems herein, including the system 100, can comprise at least one hardware processor and at least one memory coupled to the at least one hardware processor. In some examples, two or more elements of system 100 are implemented by a single computing device and/or two or more elements of system 100 are co-located. Further, one or more elements of system 100 can be implemented in a cloud computing environment, as described further below with reference to FIG. 14.

In the example, server computing system 102 includes processor(s) 108, memory 110, applications 112, and a test automation tool 114. Server computing system 102 can include an on-premises server, a cloud-deployed virtual machine, or another suitable type of computing system which can provide the functions described herein. Applications 112 can include server-side executable program code (e.g., compiled code, scripts, etc.) executing within the server computing system 102 to receive queries/requests from clients, via client computing system 104, and provide results to the clients based on the data of database 107. In the example, applications 112 include a web application backend 112A, among other applications.

Test automation tool 114 can be a proprietary test automation tool or a third-party automation tool which is used to generate and/or adapt test automates. Some examples of third-party automation tools that may be used in this context include Selenium, Katalon Studio™, Puppeteer™, Protractor, Tricentis Tosca™, and Cypress. In examples where the test automation tool 114 is a proprietary test automation tool, it can include software modules or software engines that include computer-executable instructions that, when executed, perform the functionality described herein for non-UI test automation for web applications. Alternatively, such computer-executable instructions can be packaged as a plug-in which can be installed in a proprietary or third-party automation tool such that the tool can perform the described functionality.

An example test automation tool 114A which includes the functionality described herein for non-UI test automation for web applications is shown in FIG. 1. The example test automation tool 114A includes a tracer module 114B, a mapping module 114C, and a classification module 114D, which can each be implemented as a software module or software engine. In practice, the various modules can alternatively be combined or implemented external to the example test automation tool 114A (e.g., implemented via one or more of applications 112, or implemented external to server computing system 102), and/or one or more of the modules may be excluded. Additionally or alternatively, the functionality of one or more of the modules can be performed by a third-party service.

The tracer module 114B, which can alternatively be referred to as a recorder, can include computer-executable instructions that, when executed, trace or record network requests triggered by a web application. As described further herein, the tracer module 114B can also include computer-executable instructions to determine whether a given network request is a state-change request, and if so, capture the state-change request and the response to the state-change request received from the web application backend and add it to a sequence of request-response pairs. Although the tracer module 114B also traces non-state-change requests (e.g., for inclusion in a corresponding UI test automate), the non-state-change requests are not captured and added to the sequence of request-response pairs.

The mapping module 114C can include computer-executable instructions that, when executed, determine mappings between properties of the state-change requests and properties of the responses in a given sequence of request-response pairs. For example, after a previously captured sequence of request-response pairs has been fetched, the mapping logic can be executed to identify common keys among the properties of the state-change requests and the responses, and/or among the properties of test data for the test execution and the properties of the state-change requests. After determining that the properties of a given one of the responses and the properties of one or more subsequent ones of the state-change requests comprise a common key, the mapping logic can inject data (e.g., values of the common key) from the properties of the given one of the responses into the properties of the one or more subsequent ones of the state-change requests (e.g., to replace an existing value of the common key). Similarly, after determining that the properties of the test data and the properties of one or more of the state-change requests comprise a common key, the mapping logic can inject a value of the common key from the test data into the properties of the one or more of the state-change requests. Accordingly, the mapping module 114C can preserves the sequence and data dependencies of the original sequence of request-response pairs even when new test data is used.

The classification module 114D can include computer-executable instructions that, when executed, perform operations to classify pop-up window content received in responses from the web application backend during execution of a sequence of state-change requests. For example, the operations can include determining that a response to a given state-change request comprises an indication to display a pop-up window and content for the pop-up window, as well as determining a type of the pop-up window content by applying a classification model to the pop-up window content. Towards this end, the classification module 114D can include a classification machine learning model, such as a logistic regression machine learning model that incorporates Term Frequency-Inverse Document Frequency (TF-IDF).

After determining that a response includes pop-up window content of a given type, the classification module 114D can handle the response by executing one or more additional network requests selected based on the type of the pop-up window content. For example, the handling can include triggering a network request that simulates dismissing the pop-up window if the pop-up window content type is information or warning, whereas the handling can include triggering a network request that stops the execution of the sequence of state-change requests if the pop-up window content type is error.

In the example, the client computing system 104 includes a test automation tool 124, processor(s) 126, a memory 128, a web application 130 (e.g., a web application frontend), and a UI 132. The web application 130 can be executed within a browser to render the UI 132 and process user interactions.

Client computing system 104 can also include other components (e.g., applications) which are not depicted in the example for the sake of brevity. Client computing system 104 may be a computing system operated by a user associated with a web application (e.g., an administrative user, software developer, or test engineer associated with the web application), or alternatively, a user associated with a customer that subscribes to the web application. As shown, client computing system 104 communicates with server computing system 102 and database management system 106 (e.g., via a wired or wireless connection).

Similar to test automation tool 114, test automation tool 124 can be a proprietary test automation tool or a third-party automation tool which a user of client computing system 104 uses to generate and/or adapt test automates. Test automation tool 124 can be a client application associated with the test automation tool 114; alternatively, the test automation tool 124 can be a locally-installed test automation tool. In either case, the test automation tool 124 can include computer-executable instructions for performing non-UI test automation for web applications (e.g., software modules such as those described above with reference to example test automation tool 114A).

In the example, database management system 106 includes database 107; other components may also be included in database management system 106. Database 107 includes application data 134. Application data 134 can include data defining objects accessible by applications 112 of server computing system 102 (e.g., web application backend 112A), and/or applications executing on the client computing system 104 (e.g., web application 130).

As shown, the test automation database 116 includes a plurality of UI test automates 118 and a plurality of sequences of request-response pairs 120. The UI test automates 118 can include one or more UI test automates generated by the test automation tool 114, one or more UI test automates generated by test automation tool 124, and/or one or more UI test automates generated by another entity (e.g., third-party test automates). Generation of a given UI test automate can include recording a sequence of user interactions with a UI of a web application.

A given sequence of request-response pairs can be captured by the test automation tool 114 or the test automation tool 124 during recording of a sequence of user interactions (e.g., in conjunction with generation of a corresponding UI test automate), or alternatively, during execution of an existing UI test automate (e.g., during playback of a previously-recorded sequence of user interactions). For example, the tracer module 114B can include computer-executable instructions that, when executed, capture state-change requests and corresponding responses, while ignoring non-state-change requests.

The system 100 can also comprise one or more non-transitory computer-readable media having stored therein computer-executable instructions that, when executed by the computing system, cause the computing system to perform any of the methods described herein.

In practice, the systems shown herein, such as system 100, can vary in complexity, with additional functionality, more complex components, and the like. For example, the server computing system 102, client computing system 104, database management system 106, and test automation database 116 can each include additional components and complexity.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the tracer module 114B, mapping module 114C, classification module 114D, UI test automates 118, sequences of request-response pairs 120, and the like can be stored in one or more computer-readable storage media or computer-readable storage devices. The technologies described herein can be generic to the specifics of operating systems or hardware and can be applied in any variety of environments to take advantage of the described features.

### Example 5—Example Method of Capturing a Sequence of Request-Response Pairs

The content exhibited by a software application such as a web application relies heavily on network-level interactions or calls, referred to herein as network requests.

Network requests initiated by a web application can include network requests to fetch data as well as network requests for loading structure and style files. Network requests for loading structure and style files influence how the application presents and interacts with its content according to predefined templates or formats. The structure and style files significantly contribute to rendering these content pieces into a functional application interface. However, to gain precise results via non-UI test automation of web applications using network requests, the disclosed techniques selectively filter only the necessary or relevant networks requests (e.g., by capturing state-change requests and not capturing non-state-change requests.)

FIG. 2 is a flowchart of an example method 200 of capturing a sequence of request-response pairs. In particular, during creation of a UI test automate, or during execution of a previously created UI test automate, user interactions with a web application are recorded. In accordance with disclosed techniques, the network requests triggered by the user interactions (which in turn trigger state-change operations at the web application backend) are captured along with corresponding network responses (network responses are alternatively referred to herein simply as responses). Method 200 can be performed by the system of FIG. 1, for example. In such an example, the network requests can be recorded by a tracer module such as tracer module 114B of FIG. 1).

The network requests can be XMLHttpRequest (XHR) requests which act to form a communication bridge between a web application (e.g., web application 130 of FIG. 1) and server-side data resources for data retrieval and interaction. The state-change operations can include Create, Read, Update, and Delete (CRUD) actions, or other types of state-change operations.

At 202, a user interaction with a UI of a web application is detected during generation of a UI test automate for a test case. The user interaction can include, for example, an input, a click, or an enter action which is communicated from the web application frontend to the web application backend through a corresponding network request.

At 204, the user interaction is stored. For example, method 200 can be performed during recording of a UI test automate for a given test case, in which case the user interaction can be stored as part of the UI test automate (e.g., in a test automation database such as test automation database 116 of FIG. 1).

At 206, the method includes determining whether the user interaction triggered a state-change request. In some examples, the determination is performed via a code snippet (e.g., a set of computer-executable instructions) which monitors network requests initiated by a web application to identify state-change requests among the network requests. Example code 300 for monitoring network requests to identify state-change requests is shown in FIG. 3. In particular, example code 300 implements an event listener (e.g., an XHR listener) configured to detect state-change requests. As shown, upon detection of a state-change request, example code 300 invokes a state change handler function. Example code 310 for the state change handler function is also shown in FIG. 3.

Returning to 206, if the answer is NO, indicating that the network request is not a state-change request, the method proceeds to 208 to await detection of the next interaction. For example, method 200 can be performed iteratively during recording of user interactions for a given test case.

Otherwise, if the answer at 206 is YES, indicating that the network request is a state-change request, the method proceeds to 210 to capture the state-change request and the corresponding response (e.g., by executing a state change handler function). The state change handler function can be invoked after the state of a given network request changes to DONE, indicating that the network request has triggered a state change operation at the web application backend.

The state change handler function is responsible for filtering required network requests (e.g., only XHR requests that are state-change requests) and capturing certain attributes of the filtered network requests such as the request URL and payload. As shown in the example code 310, when executed, the state change handler function can capture a state-change request and the response thereto by storing the state-change request and response in a payload of a structured object (e.g., a JSON payload) in which each interacted control (e.g., each state-change request triggered by a user interaction with the web application) is referenced with a key-value pair.

After capturing and storing the state-change request and response at 210, the method 200 proceeds to 208 to await detection of the next user interaction. When all user interactions associated with a given test case have been performed, the method 200 can be terminated (e.g., automatically or via user intervention).

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, triggering a network request can be described as executing a network request depending on perspective.

### Example 6—Example Web Applications

The technologies described herein can be integrated into stateful web applications such as HTMLGUI or WebGUI applications associated with platforms such as SAP S/4HANA or SAP S/4HANA Cloud available from SAP SE of Walldorf, Germany. HTMLGUI or WebGUI applications are configured to render content in web browsers and communicate with the server using network requests referred to as RESTGUI calls. A RESTGUI call is one subtype of an XHR request.

Each HTMLGUI or WebGUI application is associated with a unique code referred to as a transaction code (“T-code”). The T-code for a given HTMLGUI or WebGUI application can be used to generate a unique session ID. The session ID can acts as a primary identifier to understand the state of the application for subsequent network requests (i.e., subsequent RESTGUI calls).

Generation of a test automate for an HTMLGUI or WebGUI application can include first recording the corresponding T-code. Next, user interactions with the web application such as input, click, and enter actions are communicated to the server through RESTGUI calls. The response to a given RESTGUI call sent from the server to the browser includes the state of the web application.

In examples where the network requests are RESTGUI calls, the above-described method 200 of capturing a sequence of request-response pairs described can include determining whether a given user interaction triggered a RESTGUI call which is a state-change request (i.e., a RESTGUI call which triggered corresponding state-change operations at the web application backend). If so, the RESTGUI call and the response thereto received from the web application backend is captured in its native structured format and stored in a structured payload such as a JSON or XML payload). In the structured payload, each interacted control is referenced with a corresponding key-value pair. Accordingly, in such examples, a captured sequence of request-response pairs can include a plurality of key-value pairs corresponding to respective pairs of RESTGUI calls and responses.

### Example 7—Example Capturing Technique for a Sales Document Creation Web Application

In an illustrative example, the web application is a sales document creation web application. FIG. 4 is a block diagram of an example UI 400 displaying editable fields in which an end user can enter data (e.g., values of keys) for a sales document. In the example, the UI 400 includes an Order Type field and several fields pertaining to Organizational Data relevant to the sales document (i.e., a Sales Organization field, a Distribution Channel field, a Division field, a Sales Office field, and a Sales Group field). The UI 400 also includes a clickable Continue button, among other elements. In other examples, the web application can be a different type of web application, and/or the UI 400 can include different elements.

In the example, the Order Type, Sales Organization, Distribution Channel, and Division Fields are populated with respective values entered during recording of user interactions associated with a given test case; values were not entered in the Sales Office and Sales Group fields during the recording.

In accordance with an example capturing technique, as the values are entered in the fields of the UI 400, user interactions such as clicks in the fields and data entry in the fields trigger a series of non-state-change requests which are not captured. A user interaction clicking the Continue button then triggers a state-change request carrying information regarding the data entered in the fields and information regarding the Continue button. The state-change request can be captured (e.g., via execution of a state change handler function invoked by an event listener, as described above with reference to FIG. 3). After receiving the state-change request, the web application backend issues a response to the web application which indicates the state of the web application and is captured along with the state-change request. After all user interactions have been performed for the test case, a captured sequence of request-response pairs is stored for the test case; the sequence can subsequently be fetched in response to a prompt to perform a non-UI automated test for the test case, as detailed below.

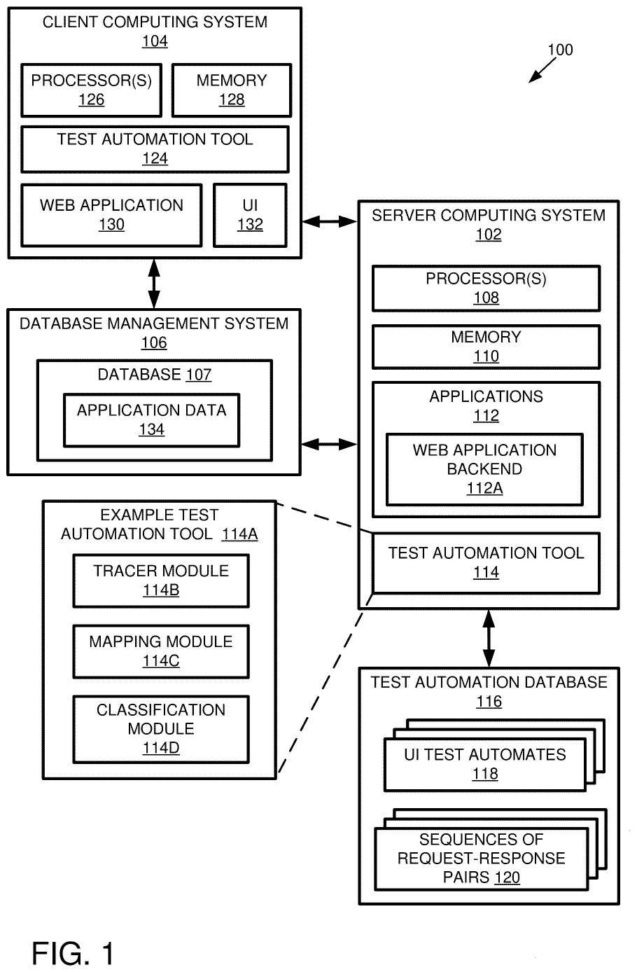

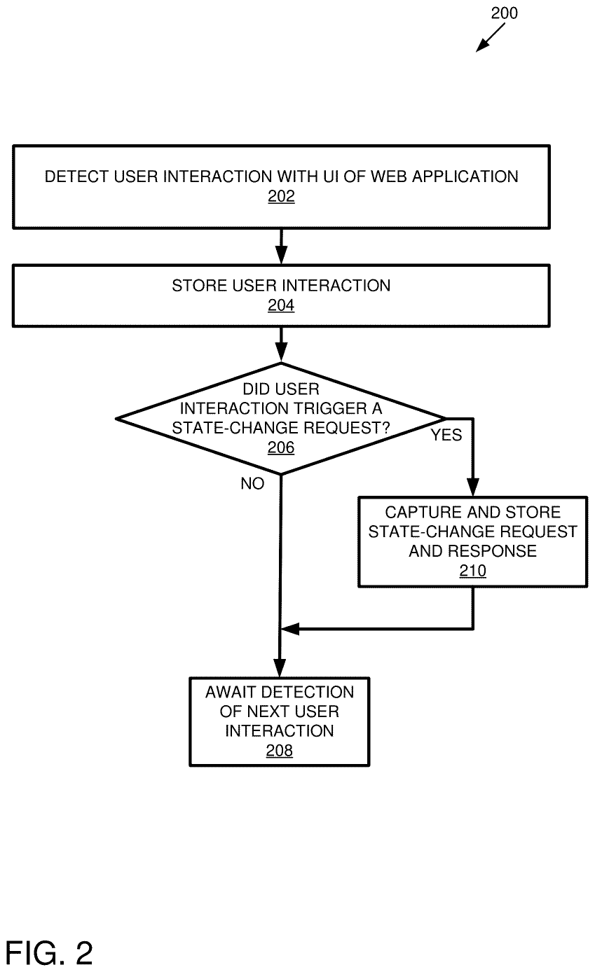

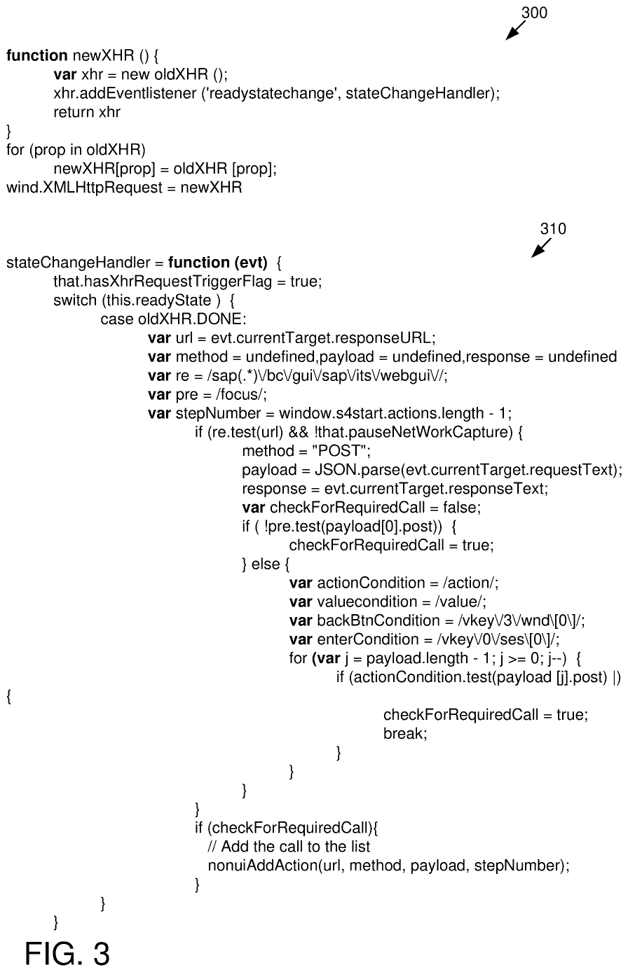

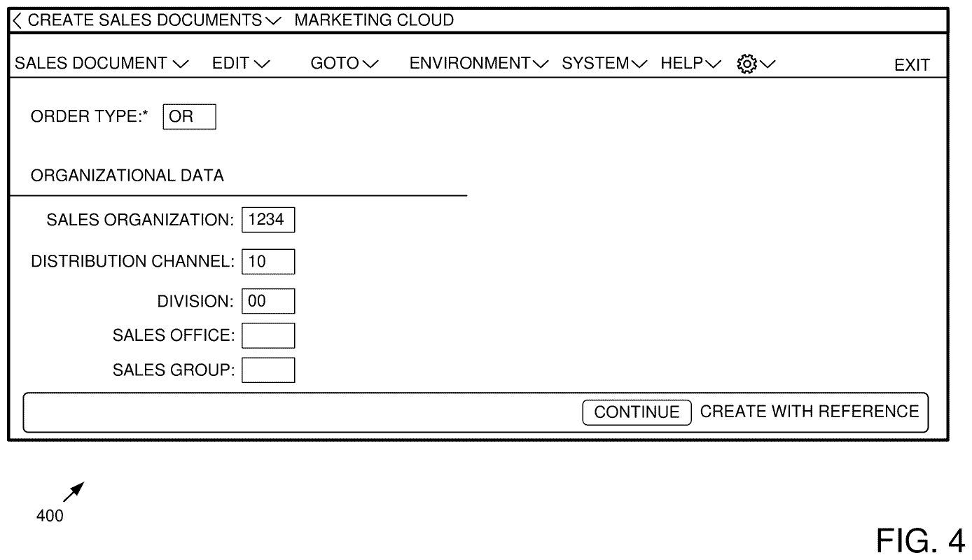

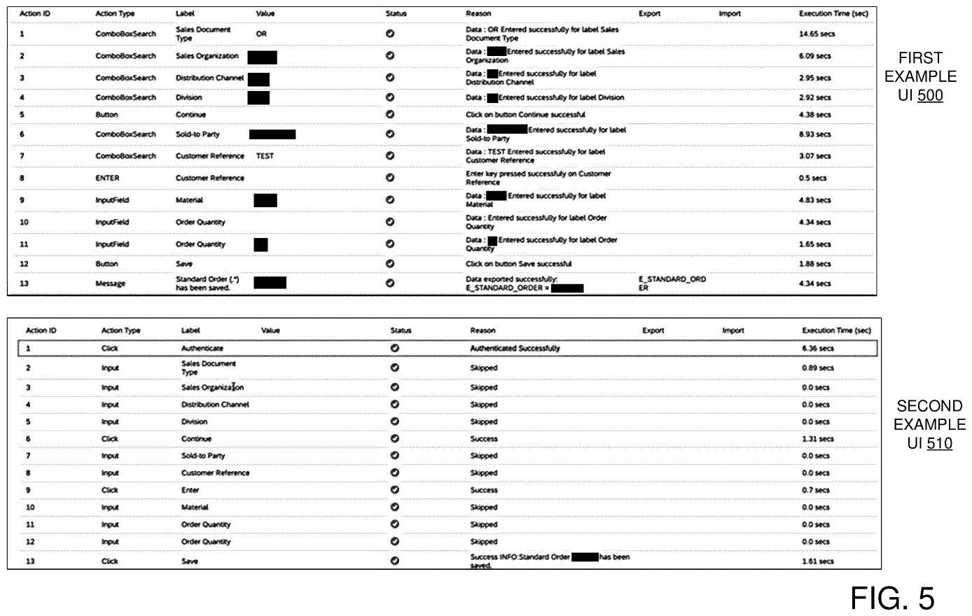

FIG. 5 is a block diagram of an first example UI 500 and a second example UI 510. Whereas UI 400 of FIG. 4 is displayed as part of the sales document creation web application (e.g., via a browser in which the application is rendered), the first example UI 500 and the second example UI 510 are displayed to administrative users or developers associated with the sales document creation web application. Certain data in the first example UI 500 and the second example UI 510 is redacted to protect sensitive information.

The first example UI 500 displays information regarding execution of a UI test automate in which recorded user interactions for a given test case are played back in sequence. Notably, the user interactions listed in the first example UI 500 include user interactions that trigger non-state-change requests as well as user interactions that trigger state-change requests.

In contrast, the second example UI 510 displays information regarding execution of a sequence of state-change requests (e.g., a non-UI test automate) for a given test case. As shown, the second example UI 510 includes a list of thirteen recorded user interactions for the given test case which are assigned respective Action IDs, Action Types, and Labels. As shown, during execution of the non-UI test automate for the given test case, non-state-change requests are skipped; as a result, fewer network requests are triggered as compared to the execution of the UI test automate described above with reference to the first example UI 500. In the example, only four of the thirteen user interactions for the given test case trigger state-change requests, and thus only those four state-change requests are triggered (i.e., Action IDs 1, 6, 9, and 13, all of which are of Action Type “Click”).

Example code 600 for a state-change request initiated by a Continue button click is shown in FIG. 6. In particular, in example code 600, test data representing data entered during a series of user interactions is aggregated in a JSON payload of a state-change request which is triggered as part of a sequence of state-change requests which collectively perform a non-UI automated test. In the example, the test data entered in the fields are stored as key-value pairs, whereas the final click action is stored as a virtual key action.

### Example 8—Example Method of Performing an Automated Test for a Web Application

FIG. 7 is a flowchart of an example method 700 of performing an automated test for a web application and can be performed, for example, by the system of FIG. 1 (e.g., in conjunction with the method of FIGS. 2, 8, and 11). The automated test can be a UI test automate or a non-UI test automate. In either case, performing the automated test can alternatively be referred to as executing the automated test or running the automated test.

In the example, at 702, a prompt to perform an automated test associated with a test case is received. Responsive to the prompt, the method determines at 704 whether a non-UI automated test is indicated. For example, the prompt may include an indication to perform a non-UI automated test or an indication to perform a UI automated test, which in turn may be generated based on user input to a test automation tool. As shown at 702A, the prompt can optionally include user-provided test data.

If the answer at 704 is NO, the method proceeds to 706 to fetch a UI test automate for the test case. At 708, the method includes launching a browser and executing the UI test automate in the browser. As described herein, executing a UI test automate can include playing back a sequence of recorded user interactions in a browser. At 710, the method includes exporting values and logging results of the test execution.

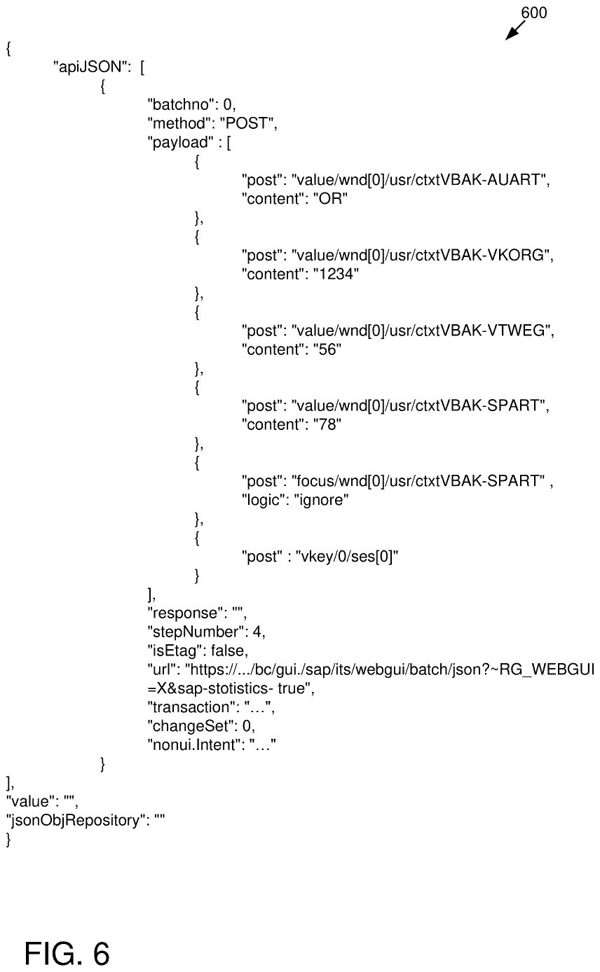

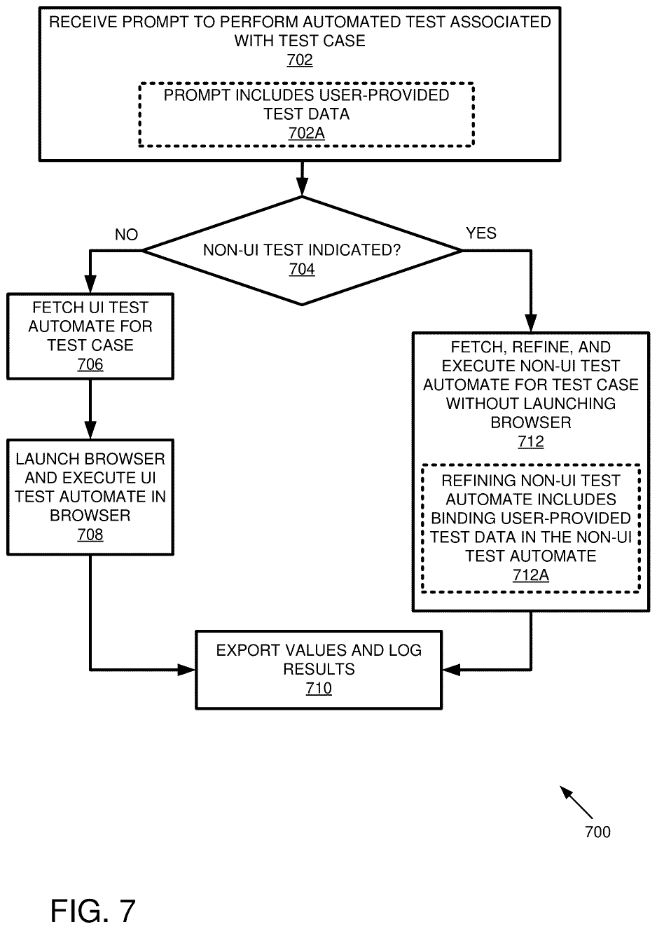

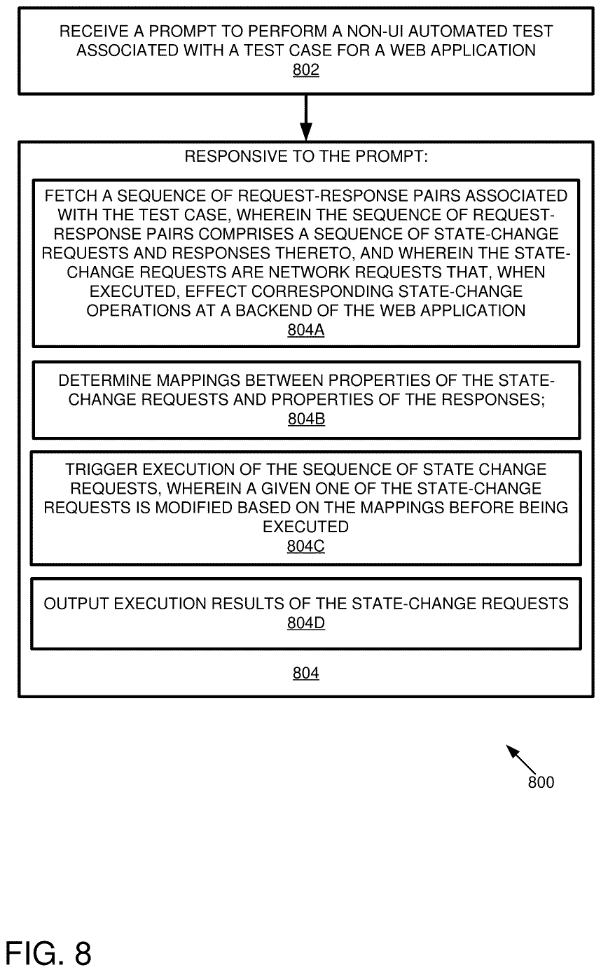

Otherwise, if the answer at 704 is YES, the method proceeds to 712 to fetch, refine, and execute a non-UI test automate for the test case without launching a browser (i.e., without launching a dedicated browser for the test execution). Disclosed techniques for refining and executing a non-UI test automate are described in further detail below with reference to FIG. 8. As shown at 712A, refining the non-UI test automate can optionally include binding user-provided test data (e.g., user-provided test data included in the prompt) in the non-UI test automate. For example, binding user-provided test data in the non-UI test automate can include determining mappings between properties of state-change requests of the non-UI test automate and properties of the test data and modifying the properties of the state-change requests based on the mappings.

After 712, the method proceeds to 710 to export values and log results of the test execution.

Herein, references to an automated testing process can be understood as referring to a process which is initiated and performed without human intervention (e.g., solely by a computing system). For example, a server computing system such as server computing system 102 of FIG. 1 may include non-transitory computer-readable media storing instructions that, when executed, initiate and perform an automated testing process. Alternatively, another computing system or component of a computing system can initiate and/or perform the automated testing process.

### Example 9—Example Method of Responding to a Prompt to Perform a Non-UI Automated Test

FIG. 8 is a flowchart of an example method 800 of responding to a prompt to perform a non-UI automated test (e.g., for a web application test case). Method 800 can be performed, for example, by the system of FIG. 1 (e.g., in conjunction with the method of FIGS. 2, 7, and 11). For example, certain steps for method 800 can be performed at step 712 of method 700 to fetch, refine, and execute (e.g., run) a non-UI test automate.

In the example, at 802, a prompt to perform a non-UI automated test associated with a test case for a web application is received. The prompt can specify the test case along with an indication that a non-UI automated test should be performed (e.g., as opposed to a UI automated test). The prompt can also include test data for the test. In some examples, the web application is an HTMLGUI or WebGUI application.

A series of actions are then performed at 804 in response to the prompt. At 804A, the method includes fetching a sequence of request-response pairs associated with the test case. The sequence of request-response pairs comprises a sequence of state-change requests and responses thereto. The state-change requests are network requests that, when executed, effect corresponding state-change operations at a backend of the web application. As described herein, the sequence of state-change requests can be a subset of a sequence of recorded network requests for the test case which includes the state-change requests along with one or more non-state-change requests which do not trigger corresponding state-change operations at the backend of the web application. In some examples, the state-change requests are RESTGUI calls triggered by user interactions with an HTMLGUI or WebGUI application.

At 804B, the method includes determining mappings between properties of the state-change requests and properties of the responses to the state-change requests. For example, determining the mappings between the properties of the state-change requests and the properties of the responses can include determining that the properties of a response to a preceding state-change request and the properties of a given one of the state-change requests that is executed after the preceding state-change request during the execution of the sequence of state-change requests comprise a common key. Additionally or alternatively, the method can include determining mappings between properties of the state-change requests and properties of the test data.

At 804C, the method includes triggering execution of the sequence of state-change requests, wherein a given one of the state-change requests is modified based on the mappings before being executed. For example, triggering execution of the sequence of state-change requests can include triggering execution of the preceding state-change request and receiving a response to the preceding state-change request, wherein properties of the response to the preceding state-change request comprise a value of the common key. Triggering execution of the sequence of state-change requests can further include injecting the value of the common key into the properties of the given one of the state-change requests before triggering execution of the given one of the state-change requests.

In examples where mappings between properties of the state-change requests and properties of the test data are determined, triggering execution of the sequence of state-change requests can further include modifying the properties of the state-change requests based on the mappings between the properties of the state-change requests and the properties of the test data. Modifying the properties of the state-change requests based on the mappings between the properties of the state-change requests and the properties of the test data can include, for example, determining that the properties of the test data and the properties of the given one of the state-change requests comprise a common key. A value of the common key can be injected from the test data into the properties of the given one of the state-change requests before triggering execution of the given one of the state-change requests.

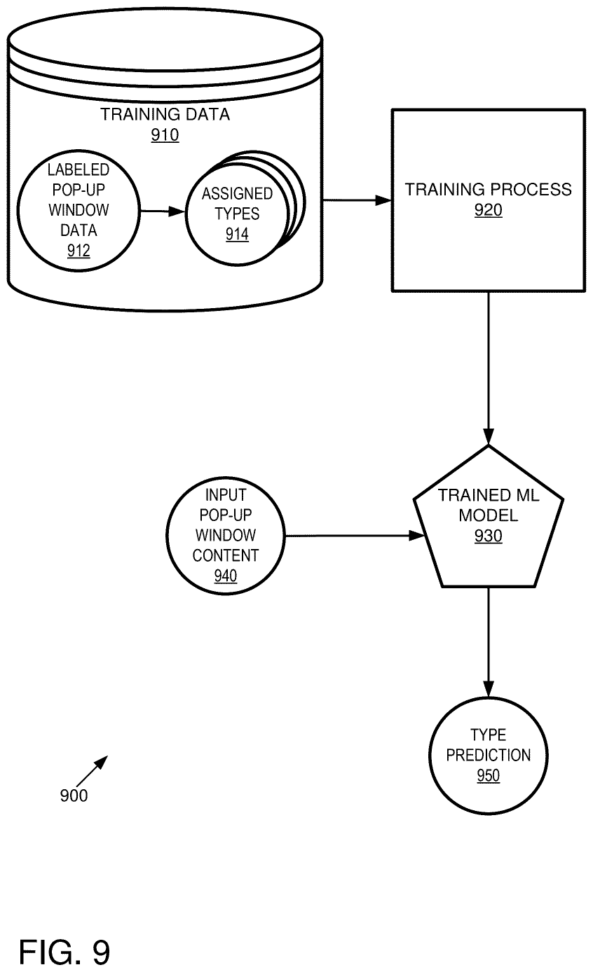

As described further below with reference to FIGS. 9-11, a classification model can be applied to pop-up window content received in response to a stage-change request during the execution of the sequence of state-change requests, to determine a type of the pop-up window content. One or more network requests selected based on the type of the pop-up window content can be triggered to simulate dismissal of a pop-up window, such that execution of the state-change requests can proceed or be terminated (e.g., when the pop-up window content indicates an error).

At 804D, the method includes outputting execution results of the state-change requests. For example, the execution results can include one or more values received in response to one or more of the state-change requests. Additionally or alternatively, the execution results can include status information (e.g., an indication that a given state-change request was successfully executed by the web application backend).

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### Example 10—Example System Implementing Machine Learning for Classification of Pop-Up Window Content

FIG. 9 is a block diagram of an example system 900 implementing machine learning to classify pop-up window content. In the example, the system 900 can include training data 910 that comprises a labeled pop-up window data 912 and assigned types 914. The labeled pop-up window data 912 can include content of pop-up windows received in responses to network requests (e.g., XML responses) with respective labels indicating types of the pop-up window content. The types can include, for example, an information type, a warning type, and an error type.

The training data 910 is used as input to a training process 920 that produces a trained machine learning model 930, which accepts input pop-up window content 940 and generates a type prediction 950 for the input pop-up window content 940. For example, the trained machine learning model 930 can be a classification model that predicts a type of the input pop-up window content 940 (e.g., information, warning, or error) based on the frequency of certain terms therein, and/or based on other factors, which in turn is output as the type prediction 950.

In some examples, the trained machine learning model 930 is a logistic regression machine learning model. In such examples, the logistic regression machine learning model can optionally include Term Frequency-Inverse Document Frequency (TF-IDF). TF-IDF is a feature extraction technique that transforms raw text (e.g., raw text included in response data received for a non-UI request) into numerical representations. These representations capture the importance of words in a text segment (e.g., words in response data) relative to the entire dataset. The TF-IDF technique focuses on Term Frequency (TF) and Inverse Document Frequency (IDF). TF measures how often a word appears; words that appear frequently in a specific text segment are given higher weight. IDF reduces the weight of words that are common across many text segments (e.g., “the,” “is,” “and”). In the context of the disclosed techniques, this helps the machine learning model 930 to focus on words that are more informative for classification of pop-up window content, such as “error,” “critical,” or “info.”

In practice, the training data 910 can include significantly more training data so that predictions can be validated. Further, there can be additional functionality within the training process.

### Example 11—Example Pop-Up Window

When automated UI test executions are performed across different systems or at different time intervals (e.g., due to different configurations and/or data in the systems), the playback of a given network request can trigger display of a pop-up window (e.g., an information, warning, or error pop-up window). A given pop-up window can be triggered by code in a response to a network request. The code can include a pop-up window content (e.g., text to be displayed in a pop-up window) in a structured format (e.g., XML).

FIG. 10 depicts an example pop-up window 1000 as well as an example response 1010 comprising pop-up window content. A pop-up window such as example pop-up window 1000 can be triggered by a response to a network request such as the example response 1010. The pop-up window content from the example response 1010 can serve as an input to a classification model such as the trained machine learning model 930 of FIG. 9. In the example, the pop-up window 1000 is an information pop-up window.

### Example 12—Example Method of Classifying Pop-Up Window Content

FIG. 11 is a flowchart of an example method 1100 of classifying pop-up window content while performing a non-UI automated test for a web application. Method 1100 can be performed by the system of FIG. 1 (e.g., in conjunction with the method of FIGS. 2, 7, and 8).

In the example, at 1102, a state-change request is executed. At 1104, a response to the state-change request is received. At 1106, the method includes determining that the response to the state-change request includes pop-up window content.

At 1106, a classification model is applied to the pop-up window content to determine a type of the pop-up window content. For example, the trained machine learning model 930 of FIG. 9 can be applied to the pop-up window content.

After determining the type of the pop-up window content, the method proceeds to 1108 to handle the response to the state-change request by triggering execution of one or more additional network requests, wherein the one or more additional network requests are selected based on the type of the pop-up window content. For example, when the type of the pop-up window content is information or warning, the handling can include triggering execution of one or more additional network requests, wherein the one or more additional network requests are selected based on the type of the pop-up window content. In contrast, when the type of the pop-up window content is error, the handling can include triggering execution of a network request that stops the execution of the sequence of state-change requests (i.e., stopping the non-UI automated test).

### Example 13—Example Implementations

Any of the following can be implemented.
Clause 1. A computer-implemented method comprising: receiving a prompt to perform a non-user-interface (non-UI) automated test associated with a test case for a web application; and responsive to the prompt: fetching a sequence of request-response pairs associated with the test case, wherein the sequence of request-response pairs comprises a sequence of state-change requests and responses thereto, and wherein the state-change requests are network requests that, when executed, effect corresponding state-change operations at a backend of the web application; determining mappings between properties of the state-change requests and properties of the responses to the state-change requests; triggering execution of the sequence of state-change requests, wherein a given one of the state-change requests is modified based on the mappings before being executed; and outputting execution results of the state-change requests.
Clause 2. The method of Clause 1, wherein: a sequence of recorded user interactions for the test case comprises user interactions that trigger the state-change requests and user interactions that trigger one or more non-state-change requests, wherein the one or more non-state-change requests do not trigger corresponding state-change operations at the backend of the web application.
Clause 3. The method of Clause 2, wherein the prompt comprises test data for the test.
Clause 4. The method of Clause 2 or Clause 3, wherein the prompt is a first prompt, the method further comprising: receiving a second prompt to perform a UI automated test associated with the test case; and responsive to the second prompt: fetching a UI test automate for the test case, wherein the UI test automate comprises the sequence of recorded user interactions; executing the UI test automate; and outputting execution results of the UI test automate.
Clause 5. The method of any one of Clauses 2-4, wherein the network requests comprise XMLHttpRequest (XHR) requests.
Clause 6. The method of any one of Clauses 1-5, wherein: the given one of the state-change requests is executed after a preceding state-change request of the sequence during the execution of the sequence of state-change requests; and determining the mappings between the properties of the state-change requests and the properties of the responses comprises determining that the properties of the response to the preceding state-change request and the properties of the given one of the state-change requests comprise a common key.
Clause 7. The method of Clause 6, wherein triggering execution of the sequence of state-change requests further comprises: triggering execution of the preceding state-change request; receiving a response to the preceding state-change request, wherein properties of the response to the preceding state-change request comprise a value of the common key; and injecting the value of the common key into the properties of the given one of the state-change requests before triggering execution of the given one of the state-change requests.
Clause 8. The method of Clause 3, further comprising determining mappings between properties of the state-change requests and properties of the test data.
Clause 9. The method of Clause 8, wherein triggering execution of the sequence of state-change requests further comprises: modifying the properties of the state-change requests based on the mappings between the properties of the state-change requests and the properties of the test data.
Clause 10. The method of Clause 9, wherein modifying the properties of the state-change requests based on the mappings between the properties of the state-change requests and the properties of the test data comprises: determining that the properties of the test data and the properties of the given one of the state-change requests comprise a common key; and injecting a value of the common key from the test data into the properties of the given one of the state-change requests before triggering execution of the given one of the state-change requests.
Clause 11. The method of any one of Clauses 1-10, further comprising: determining that a given response received during the execution of the sequence of state-change requests comprises pop-up window content; determining a type of the pop-up window content, wherein determining the type of the pop-up window content comprises applying a classification machine learning model to the pop-up window content; and handling the given response by triggering execution of one or more additional network requests, wherein the one or more additional network requests are selected based on the type of the pop-up window content.
Clause 12. The method of Clause 11, wherein handling the given response by triggering execution of the one or more additional network requests comprises: determining that the type of the pop-up window content is information or warning; and responsive to the type of the pop-up window content being information or warning, triggering execution of a network request that simulates a user interaction dismissing a pop-up window.
Clause 13. The method of Clause 11 or Clause 12, wherein handling the given response by triggering execution of the one or more additional network requests comprises: determining that the type of the pop-up window content is error; and responsive to the type of the pop-up window content being error, triggering execution of a network request that stops the execution of the sequence of state-change requests.
Clause 14. The method of any one of Clauses 11-13, wherein the classification machine learning model is a logistic regression machine learning model.
Clause 15. The method of Clause 14, wherein the logistic regression machine learning model incorporates Term Frequency-Inverse Document Frequency (TF-IDF).
Clause 16. The method of any one of Clauses 1-15, wherein the state-change operations comprise Create, Read, Update, and Delete (CRUD) actions.
Clause 17. A computing system comprising: at least one hardware processor; at least one memory coupled to the at least one hardware processor; a plurality of stored UI test automates associated with a test case for a web application, wherein a given UI test automate associated with a given test case comprises a sequence of recorded user interactions; a plurality of stored sequences of request-response pairs, wherein a given sequence of request-response pairs associated with the given test case comprises a sequence of state-change requests and responses to the state-change requests, and wherein the sequence of recorded user interactions comprises user interactions that trigger the state-change requests and user interactions that trigger one or more non-state-change requests; and one or more non-transitory computer-readable media having stored therein computer-executable instructions that, when executed by the computing system, cause the computing system to perform: receiving a prompt to perform a non-UI automated test associated with the given test case; and responsive to the prompt: fetching the given sequence of request-response pairs; determining mappings between properties of the state-change requests and properties of the responses to the state-change requests; triggering execution of the sequence of state-change requests, wherein a given one of the state-change requests is modified based on the mappings before being executed; and outputting execution results of the state-change requests.
Clause 18. The system of Clause 17, further comprising a stored classification machine learning model, wherein the computer-executable instructions further comprise computer-executable instructions that, when executed by the computing system, cause the computing system to perform, during execution of the sequence of state-change requests: determining that a given response received during the execution of the sequence of state-change requests comprises pop-up window content; determining a type of the pop-up window content, wherein determining the type of the pop-up window content comprises applying the classification machine learning model to the pop-up window content; and handling the given response by triggering execution of one or more additional network requests, wherein the one or more additional network requests are selected based on the type of the pop-up window content.
Clause 19. The system of Clause 17 or Clause 18, wherein the given sequence of request-response pairs was adapted from a pre-existing UI test automate of the plurality of stored UI test automates by executing the pre-existing UI test automate and capturing the state-change requests and the responses to the state-change requests during the execution of the pre-existing UI test automate.
Clause 20. One or more non-transitory computer-readable media comprising computer-executable instructions that, when executed by a computing system, cause the computing system to perform operations comprising: receiving a prompt to perform a non-UI automated test associated with a test case for a web application; and responsive to the prompt: fetching a sequence of request-response pairs associated with the test case, wherein the sequence of request-response pairs comprises a sequence of state-change requests and responses thereto, and wherein the state-change requests are network requests that, when executed, effect corresponding state-change operations at a backend of the web application; determining mappings between properties of the state-change requests and properties of the responses; triggering execution of the sequence of state-change requests, wherein a given one of the state-change requests is modified based on the mappings before being executed; during execution of the sequence of state-change requests: determining that a given response received during the execution of the sequence of state-change requests comprises pop-up window content; determining a type of the pop-up window content, wherein determining the type of the pop-up window content comprises applying a classification machine learning model to the pop-up window content; and handling the given response by executing one or more additional network requests, wherein the one or more additional network requests are selected based on the type of the pop-up window content; and outputting execution results of the state-change requests.

### Example 14—Example Advantages

A number of advantages can be achieved via the technologies described herein. For example, the disclosed techniques for non-UI automated testing can achieve significantly faster test executions as compared to UI automated testing.

Further, as sequence and data dependencies are automatically integrated via the mapping logic, an end user can implement the disclosed techniques for non-UI automated testing without understanding certain technical details associated with network requests (e.g., properties and chaining).

Furthermore, unexpected information or warning pop-up windows that might typically cause breaks are automatically managed such that they do not lead to failure of the test execution. The pop-ups are efficiently classified and handled as necessary without requiring user intervention.

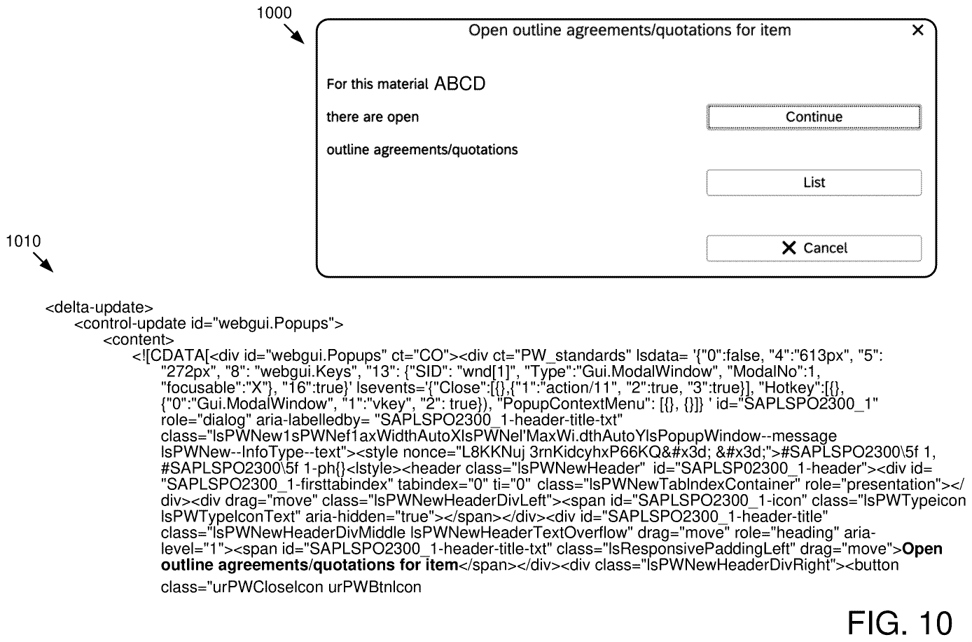

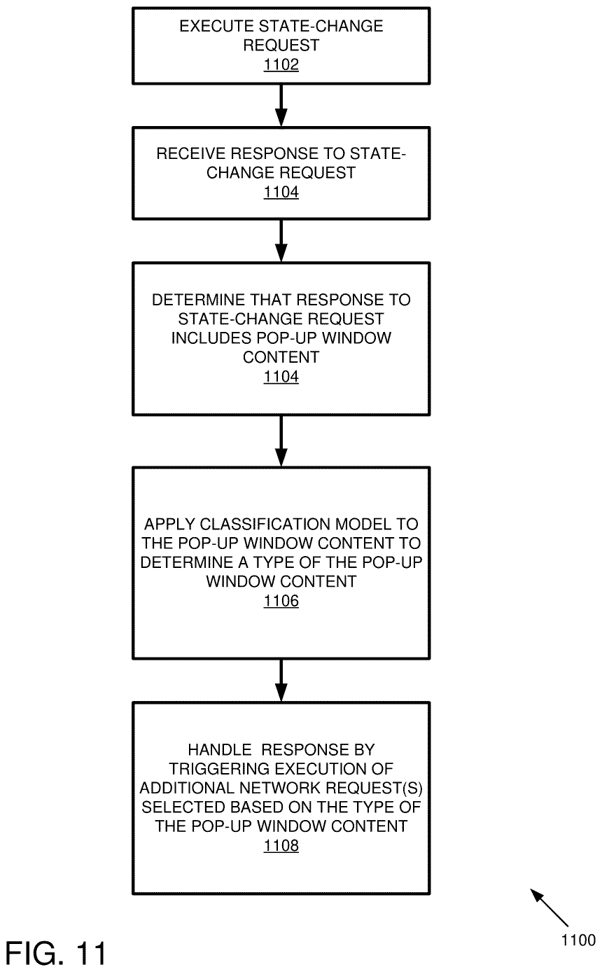

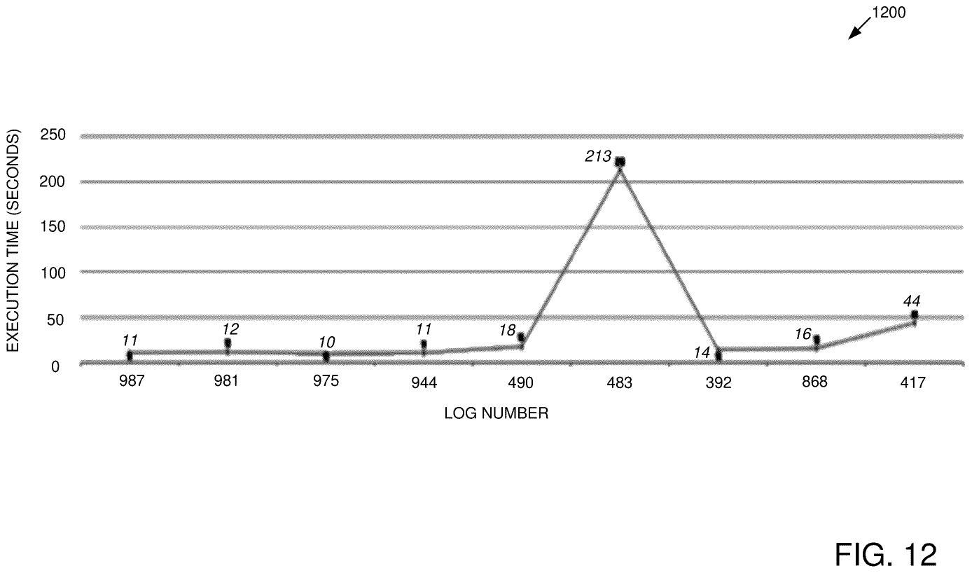

A graph 1200 showing execution times of UI automated tests and non-UI automated tests measured during performance testing of the disclosed techniques is depicted in FIG. 12. Log numbers of the tests are shown along the x-axis, execution time in seconds is shown along the y-axis, and respective execution times of the tests are labeled in italics. In the example, all tests except for the test represented by log number 483 were performed using the disclosed techniques for non-UI automated testing. The UI automated test represented by log number 483 had a significantly longer execution time as compared to the execution times of the non-UI automated tests. In particular, the execution times of the non-UI automated tests are approximately 15 times shorter than the execution time of the UI automated test (log number 483, which took 213 seconds to execute).

### Example—Example Computing Systems

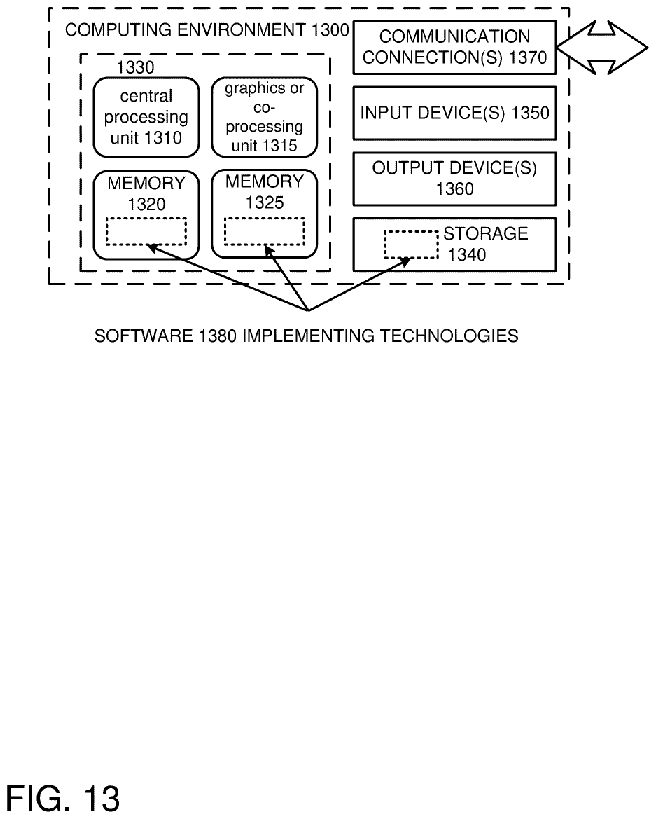

FIG. 13 depicts an example of a suitable computing system 1300 in which the described innovations can be implemented. The computing system 1300 is not intended to suggest any limitation as to scope of use or functionality of the present disclosure, as the innovations can be implemented in diverse computing systems.

With reference to FIG. 13, the computing system 1300 includes one or more processing units 1310, 1315 and memory 1320, 1325. In FIG. 13, this basic configuration 1330 is included within a dashed line. The processing units 1310, 1315 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 13 shows a central processing unit 1310 as well as a graphics processing unit or co-processing unit 1315. The tangible memory 1320, 1325 can be volatile memory (e.g., registers, cache, RAM), non-volatile memory (e.g., ROM, EEPROM, flash memory, etc.), or some combination of the two, accessible by the processing unit(s) 1310, 1315. The memory 1320, 1325 stores software 1380 implementing one or more innovations described herein, in the form of computer-executable instructions suitable for execution by the processing unit(s) 1310, 1315.

A computing system 1300 can have additional features. For example, the computing system 1300 includes storage 1340, one or more input devices 1350, one or more output devices 1360, and one or more communication connections 1370, including input devices, output devices, and communication connections for interacting with a user. An interconnection mechanism (not shown) such as a bus, controller, or network interconnects the components of the computing system 1300. Typically, operating system software (not shown) provides an operating environment for other software executing in the computing system 1300, and coordinates activities of the components of the computing system 1300.

The tangible storage 1340 can be removable or non-removable, and includes magnetic disks, magnetic tapes or cassettes, CD-ROMs, DVDs, or any other medium which can be used to store information in a non-transitory way and which can be accessed within the computing system 1300. The storage 1340 stores instructions for the software 1380 implementing one or more innovations described herein.

The input device(s) 1350 can be an input device such as a keyboard, mouse, pen, or trackball, a voice input device, a scanning device, touch device (e.g., touchpad, display, or the like) or another device that provides input to the computing system 1300. The output device(s) 1360 can be a display, printer, speaker, CD-writer, or another device that provides output from the computing system 1300.

The communication connection(s) 1370 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Example—Computer-readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### Example—Example Cloud Computing Environment

FIG. 14 depicts an example cloud computing environment 1400 in which the described technologies can be implemented, including, e.g., the system 100 of FIG. 1 and other systems herein. The cloud computing environment 1400 comprises cloud computing services 1410. The cloud computing services 1410 can comprise various types of cloud computing resources, such as computer servers, data storage repositories, networking resources, etc. The cloud computing services 1410 can be centrally located (e.g., provided by a data center of a business or organization) or distributed (e.g., provided by various computing resources located at different locations, such as different data centers and/or located in different cities or countries).

The cloud computing services 1410 are utilized by various types of computing devices (e.g., client computing devices), such as computing devices 1420, 1422, and 1424. For example, the computing devices (e.g., 1420, 1422, and 1424) can be computers (e.g., desktop or laptop computers), mobile devices (e.g., tablet computers or smart phones), or other types of computing devices. For example, the computing devices (e.g., 1420, 1422, and 1424) can utilize the cloud computing services 1410 to perform computing operations (e.g., data processing, data storage, and the like).

In practice, cloud-based, on-premises-based, or hybrid scenarios can be supported.

### Example 18—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving a prompt to perform a non-user-interface (non-UI) automated test associated with a test case for a web application; and
responsive to the prompt:
fetching a sequence of request-response pairs associated with the test case, wherein the sequence of request-response pairs comprises a sequence of state-change requests and responses thereto, and wherein the state-change requests are network requests that, when executed, effect corresponding state-change operations at a backend of the web application;
determining mappings between properties of the state-change requests and properties of the responses to the state-change requests;
triggering execution of the sequence of state-change requests, wherein a given one of the state-change requests is modified based on the mappings before being executed; and
outputting execution results of the state-change requests.

2. The method of claim 1, wherein:
a sequence of recorded user interactions for the test case comprises user interactions that trigger the state-change requests and user interactions that trigger one or more non-state-change requests, wherein the one or more non-state-change requests do not trigger corresponding state-change operations at the backend of the web application.

3. The method of claim 2, wherein the prompt comprises test data for the test.

4. The method of claim 2, wherein the prompt is a first prompt, the method further comprising:
receiving a second prompt to perform a UI automated test associated with the test case; and
responsive to the second prompt:
fetching a UI test automate for the test case, wherein the UI test automate comprises the sequence of recorded user interactions;
executing the UI test automate; and
outputting execution results of the UI test automate.

5. The method of claim 2, wherein the network requests comprise XMLHttpRequest (XHR) requests.

6. The method of claim 1, wherein:
the given one of the state-change requests is executed after a preceding state-change request of the sequence during the execution of the sequence of state-change requests; and
determining the mappings between the properties of the state-change requests and the properties of the responses comprises determining that the properties of the response to the preceding state-change request and the properties of the given one of the state-change requests comprise a common key.

7. The method of claim 6, wherein triggering execution of the sequence of state-change requests further comprises:
triggering execution of the preceding state-change request;
receiving a response to the preceding state-change request, wherein properties of the response to the preceding state-change request comprise a value of the common key; and
injecting the value of the common key into the properties of the given one of the state-change requests before triggering execution of the given one of the state-change requests.

8. The method of claim 3, further comprising determining mappings between properties of the state-change requests and properties of the test data.

9. The method of claim 8, wherein triggering execution of the sequence of state-change requests further comprises:
modifying the properties of the state-change requests based on the mappings between the properties of the state-change requests and the properties of the test data.

10. The method of claim 9, wherein modifying the properties of the state-change requests based on the mappings between the properties of the state-change requests and the properties of the test data comprises:
determining that the properties of the test data and the properties of the given one of the state-change requests comprise a common key; and
injecting a value of the common key from the test data into the properties of the given one of the state-change requests before triggering execution of the given one of the state-change requests.

11. The method of claim 1, further comprising:
determining that a given response received during the execution of the sequence of state-change requests comprises pop-up window content;
determining a type of the pop-up window content, wherein determining the type of the pop-up window content comprises applying a classification machine learning model to the pop-up window content; and
handling the given response by triggering execution of one or more additional network requests, wherein the one or more additional network requests are selected based on the type of the pop-up window content.

12. The method of claim 11, wherein handling the given response by triggering execution of the one or more additional network requests comprises:
determining that the type of the pop-up window content is information or warning; and
responsive to the type of the pop-up window content being information or warning, triggering execution of a network request that simulates a user interaction dismissing a pop-up window.

13. The method of claim 11, wherein handling the given response by triggering execution of the one or more additional network requests comprises:
determining that the type of the pop-up window content is error; and
responsive to the type of the pop-up window content being error, triggering execution of a network request that stops the execution of the sequence of state-change requests.

14. The method of claim 11, wherein the classification machine learning model is a logistic regression machine learning model.

15. The method of claim 14, wherein the logistic regression machine learning model incorporates Term Frequency-Inverse Document Frequency (TF-IDF).

16. The method of claim 1, wherein the state-change operations comprise Create, Read, Update, and Delete (CRUD) actions.

17. A computing system comprising:
at least one hardware processor;
at least one memory coupled to the at least one hardware processor;
a plurality of stored UI test automates associated with a test case for a web application, wherein a given UI test automate associated with a given test case comprises a sequence of recorded user interactions;
a plurality of stored sequences of request-response pairs, wherein a given sequence of request-response pairs associated with the given test case comprises a sequence of state-change requests and responses to the state-change requests, and wherein the sequence of recorded user interactions comprises user interactions that trigger the state-change requests and user interactions that trigger one or more non-state-change requests; and
one or more non-transitory computer-readable media having stored therein computer-executable instructions that, when executed by the computing system, cause the computing system to perform:
receiving a prompt to perform a non-UI automated test associated with the given test case; and
responsive to the prompt:
fetching the given sequence of request-response pairs;
determining mappings between properties of the state-change requests and properties of the responses to the state-change requests;
triggering execution of the sequence of state-change requests, wherein a given one of the state-change requests is modified based on the mappings before being executed; and
outputting execution results of the state-change requests.

18. The system of claim 17, further comprising a stored classification machine learning model, wherein the computer-executable instructions further comprise computer-executable instructions that, when executed by the computing system, cause the computing system to perform, during execution of the sequence of state-change requests:
determining that a given response received during the execution of the sequence of state-change requests comprises pop-up window content;
determining a type of the pop-up window content, wherein determining the type of the pop-up window content comprises applying the classification machine learning model to the pop-up window content; and
handling the given response by triggering execution of one or more additional network requests, wherein the one or more additional network requests are selected based on the type of the pop-up window content.

19. The system of claim 17, wherein the given sequence of request-response pairs was adapted from a pre-existing UI test automate of the plurality of stored UI test automates by executing the pre-existing UI test automate and capturing the state-change requests and the responses to the state-change requests during the execution of the pre-existing UI test automate.

20. One or more non-transitory computer-readable media comprising computer-executable instructions that, when executed by a computing system, cause the computing system to perform operations comprising:
receiving a prompt to perform a non-UI automated test associated with a test case for a web application; and
responsive to the prompt:
fetching a sequence of request-response pairs associated with the test case, wherein the sequence of request-response pairs comprises a sequence of state-change requests and responses thereto, and wherein the state-change requests are network requests that, when executed, effect corresponding state-change operations at a backend of the web application;
determining mappings between properties of the state-change requests and properties of the responses;
triggering execution of the sequence of state-change requests, wherein a given one of the state-change requests is modified based on the mappings before being executed;
during execution of the sequence of state-change requests:
determining that a given response received during the execution of the sequence of state-change requests comprises pop-up window content;
determining a type of the pop-up window content, wherein determining the type of the pop-up window content comprises applying a classification machine learning model to the pop-up window content; and
handling the given response by executing one or more additional network requests, wherein the one or more additional network requests are selected based on the type of the pop-up window content; and
outputting execution results of the state-change requests.
